(19) United States
(12) Patent Application Publication
(10) Pub. No.: US 2023/0129931 A1
(43) Pub. Date: Apr. 27, 2023

(54) METHOD FOR PROVIDING PARALLEL LU FACTORIZATION ON HETEROGENEOUS COMPUTING ENVIRONMENT AND NODE FOR EXECUTING THE METHOD

(71) Applicant: Seoul National University R&DB Foundation, Seoul (KR)

(72) Inventors: Jae Jin LEE, Seoul (KR); Jin Pyo KIM, Seoul (KR)

(21) Appl. No.: 17/971,489

(22) Filed: Oct. 21, 2022

(30) Foreign Application Priority Data
Oct. 22, 2021 (KR) 10-2021-0142072
Jun. 23, 2022 (KR) 10-2022-0077091
Aug. 22, 2022 (KR) 10-2022-0104880
Oct. 21, 2022 (KR) 10-2022-0136101

(51) Int. Cl. G06F 17/16

(52) U.S. Cl. CPC G06F 17/16

(57) ABSTRACT

The present disclosure relates to a parallel LU factorization technology in a heterogeneous computing environment and a parallel LU factorization providing method and a node for executing the method. By doing this, the matrix distribution of the parallel LU factorization algorithm which operates in a heterogeneous computing environment is automatically generated.

### CROSS-REFERENCE TO RELATED APPLICATION

Pursuant to 35 U.S.C. § 119, this application claims the benefit of earlier filing date and right of priority to Korean Application No. 10-2021-0142072, filed on Oct. 22, 2021, and also claims the benefit to Korean Application No. 10-2022-0077091, filed on Jun. 23, 2022, Korean Application No. 10-2022-0104880, filed on Aug. 22, 2022, and Korean Application No. 10-2022-0136101, filed on Oct. 21, 2022, the contents of which are all hereby incorporated by reference herein in their entirety.

### FIELD

The present disclosure relates to a parallel LU factorization technology in a heterogeneous computing environment, and more particularly to a method for providing a parallel LU factorization and a node for executing the method.

### BACKGROUND

The following contents described below are merely disclosed for the purpose of providing background information related to embodiments of the present disclosure, and the described contents are not always to be construed as a matter of the prior art.

Recently, according to a matrix distribution method used in the parallel LU factorization algorithm, processors are configured in a two-dimensional grid and then a matrix which performs the LU factorization is distributed to each process in a block-cyclic distribution manner. In this case, a similar amount of submatrices is distributed to all the processes.

Due to the characteristic of the parallel LU factorization algorithm, a lot of communication and synchronization between processes occur during the progress. When there is a difference in capabilities between processes in the heterogeneous computing environment, if a similar amount of matrices is assigned to all the processes according to the block-cyclic distribution manner, a running speed of the algorithm may vary for every process. By doing this, stall is caused in a process having a good capability (for example, a fast computing speed) so that there is a problem in that the efficiency of the parallel LU factorization algorithm is significantly lowered.

A matrix distribution technique which efficiently executes the parallel LU factorization algorithm in the heterogeneous computing environment is necessary.

In the meantime, the above-described related arts are technical information acquired by the inventor for the contents to be disclosed or derived from the contents to be disclosed so that it cannot be referred to as known arts disclosed to the general public prior to the filing of the present disclosure.

### SUMMARY

An object of the present disclosure is to propose a method for providing a parallel LU factorization which efficiently executes a parallel LU factorization algorithm in a heterogeneous computing environment.

An object of the present disclosure is to propose an optimal matrix distribution algorithm in consideration of a performance (for example, a computation performance, a communication performance, and a memory performance which is available for a process) of the process.

The object of the present disclosure is not limited to the above-mentioned objects and other objects and advantages of the present disclosure which have not been mentioned above can be understood by the following description and become more apparent from exemplary embodiments of the present disclosure. Further, it is understood that the objects and advantages of the present disclosure may be embodied by the means and a combination thereof in the claims.

According to an aspect of the present disclosure, a node includes at least one processor; and a memory which stores at least one instruction executable by at least one processor, and at least one instruction includes a first routine configured, when it is executed by the processor, to cause the processor to generate matrix block mapping between a plurality of matrix blocks generated by dividing the matrix to be factorized and a process grid in which a plurality of processes which processes at least one of the plurality of matrix blocks is disposed. The first routine includes a row mapping routine to determine a row unit block mapping between the block row of the matrix to be factorized and a process row of the process grid based on the process row computing performance of the process grid and a column mapping routine to determine a column unit block mapping between the block column of the matrix to be factorized and a process column of the process grid based on the process column performance of the process grid and the number of maximum matrix blocks allocable to each process.

According to an aspect of the present disclosure, a parallel LU factorization providing method includes generating matrix block matrix between a plurality of matrix blocks generated by dividing the matrix to be factorized and a process grid in which a plurality of processes to process at least one of the plurality of matrix blocks is disposed. The generating of the matrix block mapping includes determining a row unit block mapping between the block row of the matrix to be factorized and the process row of the process grid based on the process row performance of the process grid and determining a column unit block mapping between the block column of the matrix to be factorized and a process column of the process grid based on the process column performance of the process grid and the number of maximum matrix blocks allocable to each process.

According to still another aspect of the present disclosure, a node includes at least one processor; and a memory which stores at least one instruction executable by at least one processor, when the at least one instruction is executed by the processor, the at least one instruction causes the processor to perform a first operation that generate a plurality of candidate matrix block mappings representing mapping information to distribute a plurality of matrix blocks correspond to at least a part of the matrix to be factorized to a plurality of processes which executes the LU factorization, a second operation of predicting an expected LU factorization performance of the matrix to be factorized based on at least one candidate matrix block mapping which satisfies a predetermined memory limit condition, among the plurality of candidate matrix block mappings, and a third operation which determines an optimal candidate matrix block mapping for the plurality of matrix blocks among at least one candidate matrix block mapping which satisfies the memory limit condition, based on the expected LU factorization performance.

According to still another aspect of the present disclosure, a parallel LU factorization providing method includes performing a first operation of generating a plurality of candidate matrix block mappings representing mapping information to distribute a plurality of matrix blocks corresponding to at least a part of the matrix to be factorized to a plurality of processes which executes the LU factorization; performing a second operation of predicting an expected LU factorization performance of the matrix to be factorized based on at least one candidate matrix block mapping which satisfies a predetermined memory limit condition, among the plurality of candidate matrix block mappings, and performing a third operation which determines an optimal candidate matrix block mapping for the plurality of matrix blocks among at least one candidate matrix block mapping which satisfies the memory limit condition, based on the expected LU factorization performance.

Other aspects, features, and advantages other than those described above will become apparent from the following drawings, claims, and the detailed description of the present invention.

According to the exemplary embodiment, a matrix distribution method having a degree of freedom of distribution for both a process row and/or a process column is provided.

According to an exemplary embodiment, an optimal matrix distribution may be determined in consideration of a performance of a process, such as a computation performance, a communication performance, and a memory performance which is available for a process.

The effects of the present disclosure are not limited to those mentioned above, and other effects not mentioned can be clearly understood by those skilled in the art from the following description.

### BRIEF DESCRIPTION OF DRAWINGS

The above and other aspects, features, and advantages of the present disclosure will become apparent from the detailed description of the following aspects in conjunction with the accompanying drawings, in which:

FIG. 1 is an exemplary view for schematically explaining an operation environment of parallel LU factorization in a heterogeneous computing environment according to an exemplary embodiment;

FIG. 2A is a view for schematically explaining parallel LU factorization;

FIG. 2B is a view for schematically explaining parallel LU factorization;

FIG. 2C is a view for schematically explaining parallel LU factorization;

FIG. 2D is a view for schematically explaining parallel LU factorization;

FIG. 2E is a view for schematically explaining parallel LU factorization;

FIG. 2F is a view for schematically explaining parallel LU factorization;

FIG. 2G is a view for schematically explaining parallel LU factorization;

FIG. 3 is a block diagram of a node according to an exemplary embodiment;

FIG. 4 is a flowchart of a method for providing parallel LU factorization according to an exemplary embodiment;

FIG. 5 is a detailed flowchart of a matrix block mapping generating process according to an exemplary embodiment;

FIG. 6 is a view for exemplarily explaining matrix block mapping according to an exemplary embodiment;

FIG. 7 is a detailed flowchart of a matrix block mapping optimization process according to an exemplary embodiment;

FIG. 8 is a detailed flowchart of a process grid determining process according to an exemplary embodiment;

FIG. 9 is a flowchart fully illustrating a parallel LU factorization providing process according to an exemplary embodiment;

FIG. 10A is a view for exemplarily explaining a parallel LU factorization providing process according to an exemplary embodiment;

FIG. 10B is a view for exemplarily explaining a parallel LU factorization providing process according to an exemplary embodiment;

FIG. 10C is a view for exemplarily explaining a parallel LU factorization providing process according to an exemplary embodiment;

FIG. 11 illustrates a parallel LU factorization providing process according to another exemplary embodiment;

FIG. 12 is a detailed flowchart of a method for providing parallel LU factorization according to another exemplary embodiment; and

FIG. 13 is a view for explaining a method for providing parallel LU factorization according to another exemplary embodiment.

### DETAILED DESCRIPTION

Hereinafter, the present disclosure will be described in more detail with reference to the drawings. As those skilled in the art would realize, the described embodiments may be modified in various different ways, all without departing from the spirit or scope of the present invention. In the following exemplary embodiment, parts which are not directly related to the description will be descried in order to clearly describe the present disclosure. However, it does not mean that the omitted configuration is not necessary to implement a device or a system to which the spirit of the present disclosure is applied. Further, throughout the specification, the same reference numeral is used for the same or similar component.

In the following description, terms such as first, second, A, or B may be used to describe various components but the components are not limited by the above terms and are used only to distinguish one component from the other component. In the following description, a singular form may include a plural form if there is no clearly opposite meaning in the context.

In the following description, it should be understood that terms “include” or “have” indicate that a feature, a number, a step, an operation, a component, a part or the combination thereof described in the specification is present, but do not exclude a possibility of presence or addition of one or more other features, numbers, steps, operations, components, parts or combinations thereof, in advance.

The present disclosure relates to a matrix distribution method of a parallel LU factorization algorithm which operates in a heterogeneous computing environment and a method for automatically generating the matrix distribution method. The parallel LU factorization is a representative linear algebra algorithm and is an algorithm used for the high performance LINPACK (HPL) benchmark which is the de facto standard for evaluating a performance of a supercomputer system.

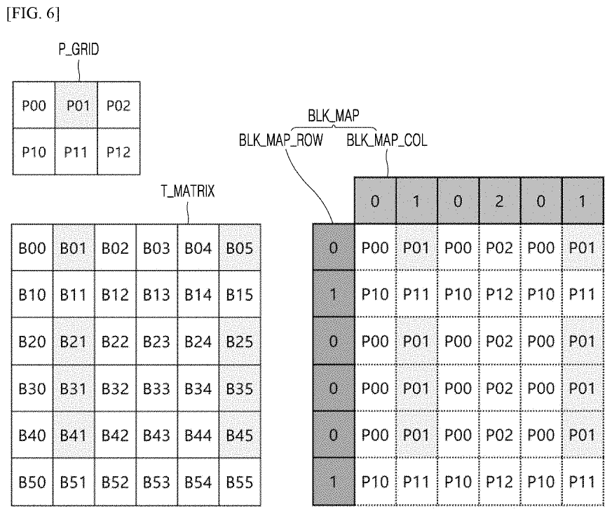

According to the parallel LU factorization, a problem of performing the LU factorization on a large real number matrix A is solved by the cooperation of several processes and is performed by a parallel LU factorization algorithm. Here, a matrix A which is a target of the LU factorization is referred as a matrix T_MATRIX to be factorized with reference to FIG. 6 to be described below.

In order to execute the parallel LU factorization algorithm, the processes should share the n×n matrix T_MATRIX to be factorized. A matrix distribution problem is to determine which part of the matrix T_MATRIX to be factorized is taken by each process at what size.

In order to distribute the two-dimensional matrix T_MATRIX to be factorized, at least one process is disposed in a P×Q two-dimensional grid. Such a two-dimensional grid is referred to as a process grid P_GRID with reference to FIG. 6 to be described below.

Hereinafter, the process row refers to a row of a process grid P_GRID and the process column refers to a column of the process grid P_GRID. That is, the P×Q process grid P_GRID is configured by P process rows and Q process columns.

According to the parallel LU factorization providing method of the exemplary embodiment, prior to execution of the parallel LU factorization algorithm, the matrix block mapping BLK_MAP is generated and optimized to provide optimal matrix distribution for the matrix T_MATRIX to be factorized.

The matrix block mapping BLK_MAP is a data structure having information about how to distribute a plurality of matrix blocks which is generated by dividing the matrix T_MATRIX to be factorized to a plurality of processes of the process grid P_GRID.

Hereinafter, the present disclosure will be described in detail with reference to the drawings.

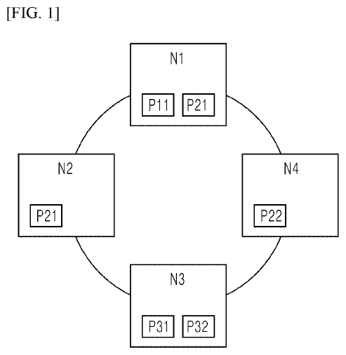

FIG. 1 is an exemplary view for schematically explaining a heterogeneous computing environment in which the parallel LU factorization according to an exemplary embodiment is executed.

The parallel LU factorization according to the exemplary embodiment may be executed in a cluster environment including a plurality of nodes N1, N2, N3, and N4.

The exemplary cluster includes a first node N1, a second node N2, a third node N3, and a fourth node N4. In FIG. 1, four nodes N1, N2, N3, and N4 are illustrated as an example and the cluster may include more or fewer number of nodes.

The performances of the nodes N1, N2, N3, and N4 which configure the cluster may not be the same. For example, the cluster may include nodes having different performances. That is, the cluster may be configured by a heterogeneous computing system.

Here, the performance of the process is performance information of a computing system (for example, a heterogeneous computing system) which executes the parallel LU factorization algorithm, and includes a computation performance, a memory performance, and a communication performance. For example, the performance of the process includes process grid (P_GRID) information, and information of a computation performance, a communication performance, and a memory performance of each process of the process grid P_GRID. For example, the performance includes information such as a CPU computation performance of each node 100, a GPU computation performance, a CPU-GPU communication performance, a communication performance between nodes, a CPU memory capacity, and a GPU memory capacity.

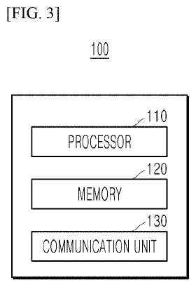

The nodes N1, N2, N3, and N4 correspond to an example of the node 100 illustrated in FIG. 3, as a computing device including a processor 110 and a memory 120 to be described with reference to FIG. 3.

Each of the nodes N1, N2, N3, and N4 includes at least one processor. The processor refers to an arithmetic processing unit such as a central processing unit (CPU) or a graphics processing unit (GPU), and includes all devices which execute a series of instructions to process a given operation without being limited thereto.

The cluster may execute a plurality of processes. The process refers to a computer program which is generated, executed, and managed to perform a given task. The operating system OS manages a state of the process and schedules a process execution order and an execution time.

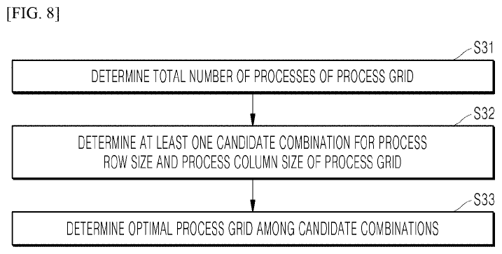

In an exemplary embodiment, the plurality of processes P11, P12, P21, P22, P31, and P32 may configure a process grid P_GRID to execute the parallel LU factorization. For example, during a process grid P_GRID configuring process to be described below with reference to FIG. 8, a plurality of processes P11, P12, P21, P22, P31, and P32 is disposed in the process grid P_GRID.

In an example illustrated in FIG. 1, the first node N1 is executing two processes P11 and P12 and the third node N3 is executing two processes P31 and P32. For example, the second node N2 is executing one process P21 and the fourth node N4 is executing one process P22.

In the exemplary embodiment, the plurality of processes P11, P12, P21, P22, P31, and P32 may be configured by a heterogeneous computing environment. For example, the performances of the plurality of processes P11, P12, P21, P22, P31, and P32 may not be the same. For example, the plurality of processes P11, P12, P21, P22, P31, and P32 may include processes having different performances.

Here, the performance includes a computation performance, a memory performance, and a communication performance. The computation performance of the process is determined based on a computation processing ability per hour of a processor which is executing the process. For example, the computation performance may be determined by the number of processors, a computation processing speed, and an availability of the processor. The memory performance of the process is determined based on a maximum memory capacity of the processor, which is executing the process, an available memory capacity of the processor, and a memory access bandwidth. The communication performance of the process is determined based on a communication performance between processors, a communication performance between nodes, a communication speed, a delay time, and a communication bandwidth.

As an example of the heterogeneous computing environment, recently, supercomputers are configured by various types of accelerators in many cases. According to the exemplary embodiment, the parallel LU factorization algorithm performance may be improved by collectively considering a performance (for example, computation performance, communication performance, and memory performance) difference between nodes (for example, nodes attached with V100 GPU of NVIDIA and nodes attached with A100 GPU) attached with accelerators having different computation performances.

As another example of the heterogeneous computing environment, the supercomputer may be configured by nodes attached with a model having a memory of 40 GB of A100 GPU of NVIDIA and a model having a memory of 80 GB. According to the exemplary embodiment, a high parallel LU factorization algorithm performance may be achieved by overcoming a memory capacity difference.

The parallel LU factorization method according to the exemplary embodiment divides a matrix T_MATRIX to be factorized which is a target of the LU factorization into a plurality of matrix blocks and generates an optimal matrix block mapping between the plurality of matrix blocks and the process grid P_GRID.

The cluster distributes the plurality of matrix blocks to the plurality of processes which configures the process grid P_GRID according to the optimal matrix block mapping. Each process executes the LU factorization on the distributed matrix block.

For example, the first node N1 includes a first processor and a second processor and the first process P11 is executed in the first processor and the second process P12 is executed in the second processor. For example, the first node N1 includes one processor and for example, executes the first process P11 and the second process P12 in a multitasking manner.

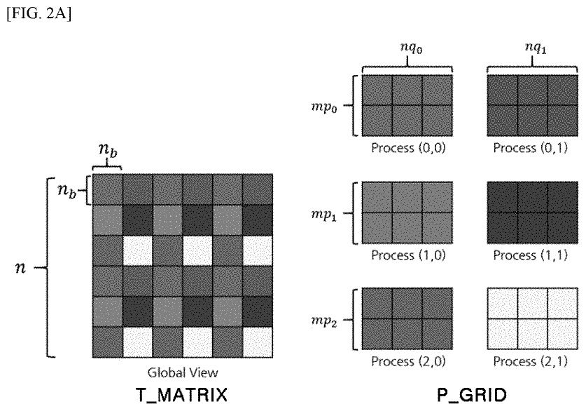

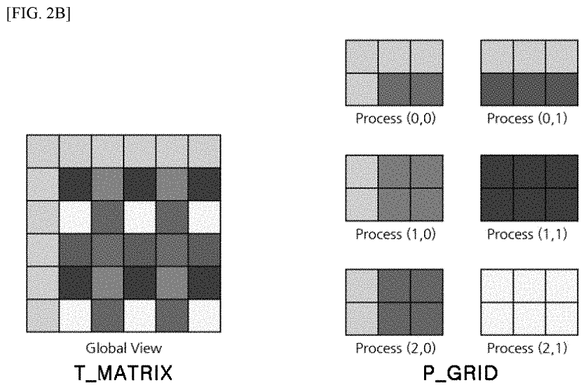

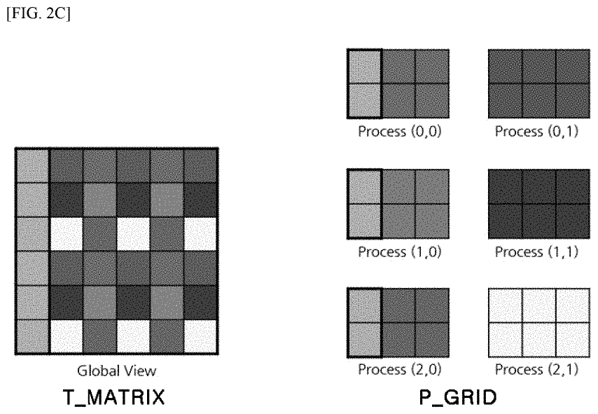

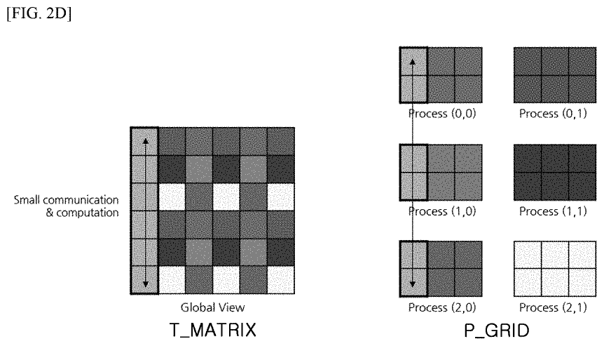

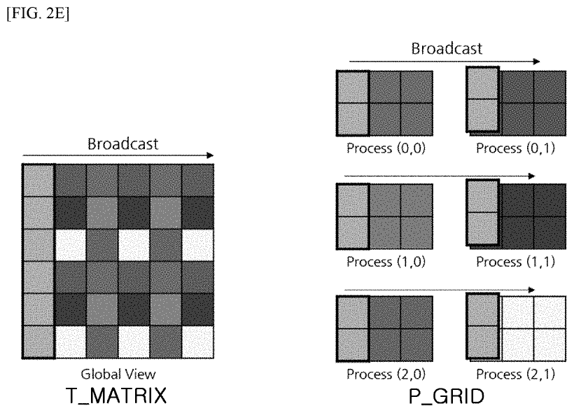

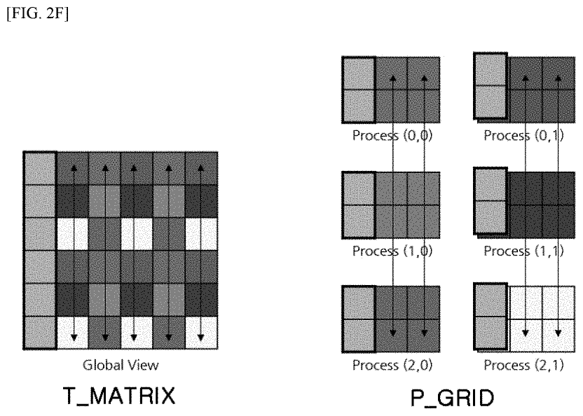

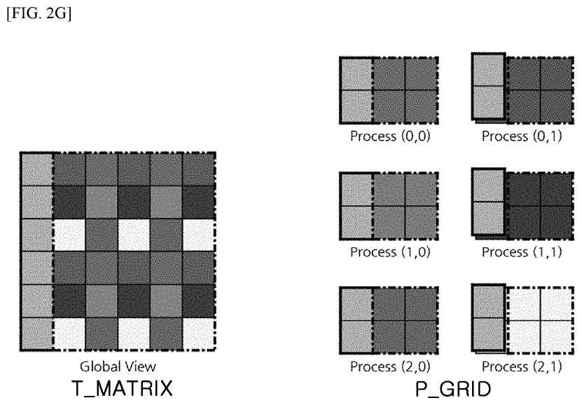

Hereinafter, the parallel LU factorization will be schematically described with reference to FIGS. 2A to 2G.

FIGS. 2A to 2G are views for schematically explaining parallel LU factorization.

The matrix distribution of the matrix to be factorized will be described with reference to FIG. 2A.

The parallel LU factorization distributes n×n matrix T_MATRIX to be factorized to each process of the process grid P_GRID. According to the matrix distribution, it is determined which part of the matrix T_MATRIX to be factorized is shared by each process at what size. The matrix distribution disposes n×n two-dimensional matrix T_MATRIX to be factorized in the P×Q two-dimensional process grid P_GRID.

The matrix T_MATRIX to be factorized is divided in n_{b}×n_{b} matrix block units to be distributed to each process. The matrix T_MATRIX to be factorized is divided into n/n_{b} block rows and n/n_{b} block columns. The block row is a row of the matrix block unit and includes n_{b} rows of the matrix T_MATRIX to be factorized. The block column is a column of the matrix block unit and includes n_{b} columns of the matrix T_MATRIX to be factorized.

A size of the matrix distributed to the process (i-th row, j-th column), that is, a process (i,j) on the process grid P_GRID is expressed by mpᵢ×nqⱼ.

FIG. 2A shows a result of distributing each submatrix of the matrix T_MATRIX to be factorized to each process in a round-robin manner. Here, n_{b}×n_{b} submatrix is referred to as a matrix block and the distribution method as described above is referred to as a block-cyclic distribution method.

The parallel LU factorization algorithm iterates a given LU factorization algorithm n/n_{b} times in total to perform the LU factorization of the matrix T_MATRIX to be factorized. When one iteration ends, the LU factorization on a leftmost block column and the uppermost block row of the matrix T_MATRIX to be factorized is completed.

FIG. 2B illustrates a matrix T_MATRIX to be factorized after first iteration.

The LU factorization of one leftmost and uppermost block row and block column represented with gray is completed in the first iteration. That is, when the first iteration ends, it is understood that a size of the matrix T_MATRIX to be factorized for which the LU factorization is not completed is (n−n_{b})×(n−n_{b}). As a result, a size of the problem to be solved is reduced by n_{b}. When this process is repeated n/n_{b} times, the LU factorization is completed.

One iteration is configured by four steps of Panel factorization-Panel broadcast-Row swap-Update trailing submatrix. Hereinafter, the four steps are denoted by FACT-BCAST-SWAP-UPDATE.

In the iteration after the first iteration, the algorithm operates only for a part in which the LU factorization is not completed and the part in which the LU factorization is completed is ignored.

A panel will be described with reference to FIG. 2C.

The panel refers to n_{b} leftmost columns of the matrix T_MATRIX to be factorized. That is, the leftmost block column of the matrix T_MATRIX to be factorized is a panel. In FIG. 2C, the panel is illustrated as a light blue area.

In each iteration, one process column of the process grid P_GRID has information corresponding to the panel. Further, the remaining part excluding the panel from the matrix T_MATRIX to be factorized is referred to as a trailing submatrix.

The FACT step will be described with reference to FIG. 2D.

In the panel factorization (FACT) step, the LU factorization is performed only in the panel while ignoring the remaining part of the matrix T_MATRIX to be factorized.

During this process, as compared with the other three steps in every process having the panel, small communication with a smaller amount of data and a larger number of times of communication and small computation with a smaller amount of data and a larger number of computations are performed.

The BCAST step will be described with reference to FIG. 2E.

In the panel broadcast BCAST step, a panel in which the LU factorization ends in the previous FACT step is transmitted to the remaining process. Information about the panel is shared with all the processes for the subsequent SWAP-UPDATE steps. In the BCAST step, a relatively larger communication occurs once for every row.

The SWAP step will be described with reference to FIG. 2F.

In the row swap (SWAP) step, all processes appropriately exchange rows of the trailing submatrix based on the panel information received in BCAST. In this step, the communication is mostly performed.

The UPDATE step will be described with reference to FIG. 2G.

In the update trailing submatrix UPDATE step, dtrsm and dgemm operations are performed on the trailing submatrix. Most of the real number computation of the LU factorization algorithm occurs in the UPDATE step. In this step, the communication is not performed.

In the meantime, in the case of the optimized LU factorization algorithm, instead of sequentially executing the FACT-BCAST-SWAP-UPDATE, several steps may be simultaneously performed. The optimized LU factorization algorithm completes the FACT-BCAST-SWAP steps of a subsequent t+1-th iteration in advance while executing the UPDATE of a t-th iteration so that the UPDATE step of the t+1-th iteration is immediately executed without waiting.

FIG. 3 is a block diagram of a node according to an exemplary embodiment.

The node 100 according to the exemplary embodiment includes a processor 110 and a memory 120.

The processor 110 is a sort of a central processing unit and executes one or more instructions stored in the memory 120 to execute the parallel LU factorization providing method according to the exemplary embodiment. The processor 110 may include any type of device which is capable of processing computation about data.

The processor 110 may refer to a data processing device embedded in hardware which has a physically configured circuit to perform a function expressed by a code or a command included in a program. Examples of the data processing units built in hardware include, but are not limited to, processing units such as a microprocessor, a central processing unit (CPU), a processor core, a multiprocessor, an application-specific integrated circuit (ASIC), a field programmable gate array (FPGA), and a graphics processing unit (GPU).

The processor 110 may include one or more processors. For example, the processor 110 may include a CPU and a GPU. For example, the processor 110 may include a plurality of GPUs. The processor 110 may include at least one core.

The memory 120 may store at least one instruction to cause the node 100 to execute the parallel LU factorization providing method according to the exemplary embodiment. The memory 120 may store an executable program which generates and executes one or more instructions which implements a parallel LU factorization providing method according to an exemplary embodiment.

The processor 110 may execute the parallel LU factorization providing method according to the exemplary embodiment based on a program and instructions stored in the memory 120.

The memory 120 may include an embedded memory and/or an external memory and also include a volatile memory such as a DRAM, an SRAM, or an SDRAM, a non-volatile memory such as an one time programmable ROM (OTPROM), a PROM, an EPROM, an EEPROM, a mask ROM, a flash ROM, an NAND flash memory, or an NOR flash memory, a flash drive such as an SSD, a compact flash (CF) card, an SD card, a micro-SD card, a mini-SD card, an Xd card, or a memory stick, or a storage drive such as a HDD. The memory 120 may include magnetic storage media or flash storage media, but the present disclosure is not limited thereto.

Additionally, the node 100 may further include a communication unit 130.

The communication unit 130 provides a communication interface which provides a transmission/reception signal between a node 100 and an external device including the other node 100 as a packet data format using a wired/wireless communication technique. Further, the communication unit 130 may be a device that includes hardware and software required for transmission/reception of control signals or data signals, and so forth, with another network device through wire-based or wireless connections.

The communication unit 130 may provide a high speed communication interface for a computer cluster configured by a plurality of nodes 100. For example, the communication unit 130 may provide a message passing interface (MPI), a parallel virtual machine (PVM), MPICH, open MPI, and the like.

The node 100 executes a parallel LU factorization providing method according to an exemplary embodiment.

The node 100 includes at least one processor 110 and a memory 120 which stores at least one instruction executable by at least one processor 110. The at least one instruction includes a first routine configured, when it is executed by the processor 110, to cause the processor 110 to generate a matrix block mapping BLK_MAP between a plurality of matrix blocks generated by dividing the matrix T_MATRIX to be factorized and the process grid P_GRID in which a plurality of processes for processing at least one of a plurality of matrix blocks is disposed.

Hereinafter, the routine is a software module including at least one instruction and may be implemented by a software function, a software class, script, or the like.

The first routine may include a row mapping routine which determines a row unit block mapping BLK_MAP_ROW between a block row of the matrix T_MATRIX to be factorized and a process row of the process grid P_GRID based on the performance for every process row of the process grid P_GRID and a column mapping routine which determines a column unit block mapping BLK_MAP_COL between a block column of the matrix T_MATRIX to be factorized and a process column of the process grid P_GRID based on a performance for every process column of the process grid P_GRID and a maximum number of matrix blocks allocable to each process.

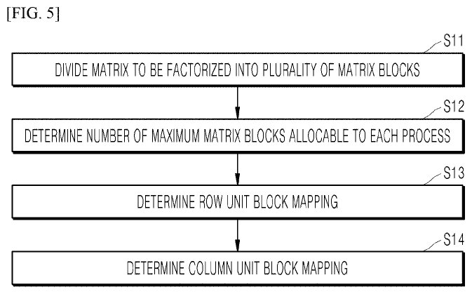

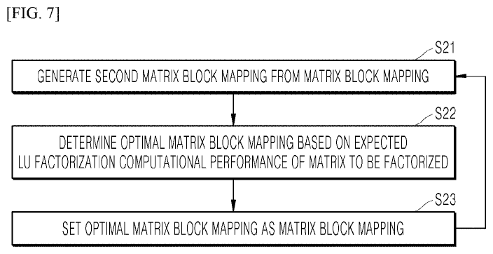

Referring to FIG. 5, the first routine corresponds to step S1 and referring to FIG. 7, the row mapping routine corresponds to step S13 and the column mapping routine corresponds to step S14, which will be described in detail with reference to corresponding drawings.

In one example, the plurality of matrix blocks corresponds to a plurality of submatrices having the same row size and column size.

The first routine may include an instruction configured to determine a maximum number of matrix blocks based on the performance of each process and a size of the matrix block.

The row mapping routine may include an instruction configured to determine a ratio of the number of times of block row assignment to a performance of the process row of the process grid P_GRID while circulating the block row of the matrix T_MATRIX to be factorized and assign a block row which is currently circulating to a process row with the lowest determined ratio.

The column mapping routine may include an instruction configured to determine a ratio of the number of times of block row assignment to a performance of the process column of the process grid P_GRID while circulating the block column of the matrix T_MATRIX to be factorized and assign a block column which is currently circulating to a process column with the lowest determined ratio without exceeding a maximum number of matrix blocks allocable to the process.

In an example, the row unit block mapping BLK_MAP_ROW and the column unit block mapping BLK_MAP_COL are arrays having a size as large as the number of block rows and the number of block columns of the matrix T_MATRIX to be factorized, respectively. The matrix block mapping BLK_MAP may provide mapping information between the matrix T_MATRIX to be factorized and the process grid P_GRID by a combination of the row unit block mapping BLK_MAP_ROW and the column unit block mapping BLK_MAP_COL.

In the meantime, at least one instruction stored in the memory 120 includes a second routine configured, when it is executed by the processor 110, to cause the processor 110 to optimize the matrix block mapping based on the expected LU factorization computational performance of the matrix T_MATRIX to be factorized.

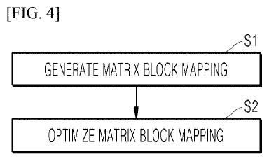

Referring to FIG. 4, the second routine corresponds to a step S2, which will be described in detail with reference to the corresponding drawing.

The second routine includes a first instruction which generates second matrix block mapping from the matrix block mapping and a second instruction which selects an optimal matrix block mapping between the matrix block mapping and the second matrix block mapping based on the expected LU factorization computational performance of the matrix T_MATRIX to be factorized.

The first instruction includes an instruction configured to execute at least one of a first swap which swaps a block column mapping assigned to different process columns in the column unit block mapping BLK_MAP_COL of the matrix block mapping BLK_MAP and a second swap which swaps a block row mapping assigned to different process rows in the row unit block mapping BLK_MAP_ROW of the matrix block mapping BLK_MAP.

The second instruction includes an instruction configured to determine an expected performance of each matrix block mapping based on the matrix block mapping BLK_MAP of the process grid P_GRID, the second matrix block mapping, a performance of a plurality of processes, and an execution parameter.

The second routine includes a third instruction configured to iterate the first instruction and the second instruction a predetermined number of times with the optimal matrix block mapping selected by the second instruction as matrix block mapping.

In the meantime, the at least one instruction stored in the memory 120 may further include a third routine configured, when it is executed by the processor 110, to cause the processor 110 to dispose the plurality of processes in the process grid P_GRID.

The third routine corresponds to steps S31 to S33 with reference to FIG. 8.

The third routine may include an instruction which is configured to determine a total number of processes of the process grid P_GRID based on a performance of at least one node which executes the plurality of processes, determine at least one candidate combination for a process row size and a process column size of the process grid P_GRID based on the total number of processes, and determine an optimal process grid for a plurality of processes for the candidate combination.

FIG. 4 is a flowchart of a method for providing parallel LU factorization according to an exemplary embodiment.

The parallel LU factorization providing method according to the exemplary embodiment provides an optimal distribution method to distribute the matrix T_MATRIX to be factorized to at least one process to execute the LU factorization of the matrix T_MATRIX to be factorized in parallel.

The parallel LU factorization providing method according to the exemplary embodiment receives a performance of the computing system to execute the parallel LU factorization algorithm and an execution parameter of the parallel LU factorization algorithm as inputs to generate an optimal matrix block mapping. The optimal matrix block mapping is a matrix block mapping BLK_MAP to cause the parallel LU factorization program to show the highest performance with a given performance and the parallel LU factorization algorithm execution parameter.

The performance includes process grid P_GRID information, the computation performance, the communication performance, and memory performance information of the process. For example, the performance includes information such as a CPU computation performance of each node 100, a GPU computation performance, a CPU-GPU communication performance, a communication performance between nodes, a CPU memory capacity, and a GPU memory capacity.

The execution parameter is a setting value required to execute the parallel LU factorization algorithm and for example, includes an entire matrix size n×n of the matrix T_MATRIX to be factorized, a matrix block size n_{b}×n_{b}, and a specific executing method of each step of the algorithm.

The parallel LU factorization providing method according to the exemplary embodiment is executed by the node 100 with reference to FIG. 3. For example, the parallel LU factorization providing method according to the exemplary embodiment is executed by one node 100 among a plurality of nodes 100 which configures a cluster. For example, the parallel LU factorization providing method according to the exemplary embodiment may be executed by a node 100 outside the cluster.

The parallel LU factorization providing method according to the exemplary embodiment includes a step S1 of generating, by the processor 110, a matrix block mapping BLK_MAP between a plurality of matrix blocks generated by dividing the matrix T_MATRIX to be factorized and a process grid P_GRID in which a plurality of processes to process at least one of the plurality of matrix blocks is disposed.

In one example, the process grid P_GRID is configured according to the cluster environment to be stored in the memory 120 in advance or acquired from an external device by means of the communication unit 130 to be referenced by the processor 110. In one example, the process grid P_GRID may be generated by the processor 110 according to the process illustrated in FIG. 8. A structure of the process grid P_GRID will be described below with reference to FIG. 6.

The step S1 of generating matrix block mapping includes a step of determining a row unit block mapping BLK_MAP_ROW between a block row of the matrix T_MATRIX to be factorized and a process row of the process grid P_GRID based on the performance for every process row of the process grid P_GRID and a step of determining a column unit block mapping BLK_MAP_COL between a block column of the matrix T_MATRIX to be factorized and a process column of the process grid P_GRID based on a performance for every process column of the process grid P_GRID and a maximum number of matrix blocks allocable to each process. The step S1 of generating matrix block mapping will be described below with reference to FIG. 4.

The parallel LU factorization providing method according to the exemplary embodiment may further include a step S2 of optimizing the matrix block mapping BLK_MAP based on an expected LU factorization computational performance of the matrix T_MATRIX to be factorized. The step S2 will be described in more detail with reference to FIG. 7.

Additionally, the parallel LU factorization providing method according to the exemplary embodiment may further include a step of disposing a plurality of processes to execute the parallel LU factorization on the matrix T_MATRIX to be factorized in the process grid P_GRID. A process grid configuring process will be described below with reference to FIG. 8.

FIG. 5 is a detailed flowchart of a matrix block mapping generating process according to an exemplary embodiment.

FIG. 5 illustrates the matrix block mapping generating step S1 in more detail with reference to FIG. 4.

The matrix block mapping generating step S1 may include a step S11 of dividing, by the processor 110, a matrix T_MATRIX to be factorized into a plurality of matrix blocks.

In one example, the plurality of matrix blocks corresponds to a plurality of submatrices having the same row size and column size. That is, in the step S11, the processor 110 may divide n×n matrix T_MATRIX to be factorized into a n_{b}×n_{b} matrix block. Here, n is a natural number and n_{b} is a natural number which is equal to or smaller than n.

The matrix block mapping generating step S1 may include a step S12 of determining, by the processor 110, a maximum number of matrix blocks allocable to each process based on the performance of each process of the process grid P_GRID and a size of the matrix block.

In step S12, the processor 110 determines a maximum number of matrix blocks which is distributed to each process based on the performance of each process. For example, the processor 110 may determine a maximum number of matrix blocks based on a memory capacity of the process.

For example, when the memory capacity of the process (i,j) is M_{(i,j)}, a maximum of M_{(i,j)}/n²_{b} blocks may be distributed. For example, in step S12, the processor 110 may determine a quotient obtained by dividing a memory space size available to the process by a memory space size required to store the matrix block as a maximum number of matrix blocks allocable to the process. For example, when the memory space available for the process is 1024 MB and one matrix block is 128 MB, the processor 110 may determine a maximum number of matrix blocks allocable to the process as 8.

In the matrix block mapping generating step S1 includes a step S13 of determining, by the processor 110, a row unit block mapping BLK_MAP_ROW between a block row of the matrix T_MATRIX to be factorized and a process row of the process grid P_GRID based on the performance for every process row of the process grid P_GRID and a step S14 of determining, by the processor 110, a column unit block mapping BLK_MAP_COL between a block column of the matrix T_MATRIX to be factorized and a process column of the process grid P_GRID based on a performance for every process column of the process grid P_GRID and a maximum number of matrix blocks allocable to each process.

In step S13, the processor 110 determines the row unit block mapping BLK_MAP_ROW between a block row of the matrix T_MATRIX to be factorized and a process row of the process grid P_GRID based on the performance for every process row of the process grid P_GRID.

To this end, the step S13 includes a step of determining, by the processor 110, a ratio of the number of times of assigning the block row to a performance of the process row of the process grid P_GRID while circulating the block row of the matrix T_MATRIX to be factorized and a step of assigning a block row which is currently circulating to a process row with a lowest determined ratio.

Here, the performance of the process row may be determined based on a sum of the performances of the processes belonging to the process row. For example, the processor 110 may determine a performance of the process row based on a total sum or a weighted sum of the performances of the processes belonging to the process row. Here, in the case of the weighted sum, a weight for the performance of the process may be determined according to an importance or a contribution of a process or a node which is executing the process. For example, the processor 110 may acquire the performance of the process row, the performance and/or the importance or the weight of the process as an input parameter.

The processor 110 may determine a performance of the process based on the computation performance, the memory performance, and the communication performance of the process. For example, the processor 110 may determine a performance of the process based on a total sum or a weighted sum of the computation performance, the memory performance, and the communication performance of the process. For example, the weight of the weighted sum may be determined according to the availability of the computation performance, the memory performance, and the communication performance of the process. For example, the processor 110 may acquire the computation performance, the memory performance, and the communication performance of the process and/or the weight/availability therefor as input parameters.

The number of times of assigning the block row is the number of times of assigning the block row to the process row and corresponds to the number of block rows assigned to the current process row.

In step S14, the processor 110 determines the column unit block mapping BLK_MAP_COL between a block column of the matrix T_MATRIX to be factorized and a process column of the process grid P_GRID based on the performance for every process column of the process grid P_GRID and a maximum number of matrix blocks allocable to each process.

To this end, the step S14 includes a step of determining, by the processor 110, a ratio of the number of times of assigning the block column to a performance of the process column of the process grid P_GRID while circulating the block column of the matrix T_MATRIX to be factorized and a step of assigning, by the processor 110, a block column which is currently circulating to a process column with a lowest determined ratio without exceeding a maximum number of matrix blocks allocable to each process.

Here, the performance of the process column may be determined based on a sum of the performances of the processes belonging to the process column. For example, the processor 110 may determine a performance of the process column based on a total sum or a weighted sum of the performances of the processes belonging to the process column. Here, in the case of the weighted sum, for example, a weight for the performance of the process may be determined according to an importance or a contribution of a process or a node which is executing the process.

The processor 110 may determine a performance of the process based on the computation performance, the memory performance, and the communication performance of the process as described above in step S13.

The number of times of assigning the block column is the number of times of assigning the block column to the process row and corresponds to the number of block columns assigned to the current process column.

In step S14, the processor 110 assigns the block column to the process column within a range which does not exceeds the maximum number of matrix blocks allocable to each process of the process column. By doing this, a matrix block may be disposed in an available process within a memory limit of the process.

In step S14, when the processor 110 assigns the block column to the process column to exceed a maximum number of matrix blocks allocable to each process of the process column, the processor 110 may omit the process column and assign a block column to a process column having a next lower assigned ratio.

In the meantime, the steps S13 and S14 may be performed in this order or in a reverse order. When the step S14 is performed prior to the step S13, the processor 110 may assign the block row to the process row within a range which does not exceed the maximum number of matrices allocable to the process row in step S13, instead of not exceeding the maximum number of matrices allocable to the process in step S14.

FIG. 6 is a view for exemplarily explaining matrix block mapping according to an exemplary embodiment.

For example, 2×3 process grid P_GRID in which six processes P00, P01, P02, P10, P11, and P12 are disposed. The exemplary matrix T_MATRIX to be factorized is divided into six block rows and six block columns to have 36 matrix blocks B00 to B55.

In step S1 referring to FIG. 4, the processor 110 determines a matrix block mapping BLK_MAP between the matrix T_MATRIX to be factorized and the process grid P_GRID by a series of matrix block mapping generating processes described above with reference to FIG. 5.

The matrix block mapping BLK_MAP includes a row unit block mapping BLK_MAP_ROW and a column unit block mapping BLK_MAP_COL. The row unit block mapping BLK_MAP_ROW and the column unit block mapping BLK_MAP_COL have an array structure having a size as large as the number of block rows and the number of columns of the matrix T_MATRIX to be factorized, respectively.

The row unit block mapping BLK_MAP_ROW represents which process row of the process grid P_GRID the block row of the matrix T_MATRIX to be factorized is assigned. That is, an i-th element of the row unit block mapping BLK_MAP_ROW stores a process row to which an i-th block row is assigned.

In the example of FIG. 6, a first value (that is, BLK_MAP_ROW[0]) of the row unit block mapping BLK_MAP_ROW is 0, which means that first block row B00, B01, B02, B03, B04, B05 of the matrix T_MATRIX to be factorized are mapped to the first process row P00, P01, P02 of the process grid P_GRID.

In a similar manner, the column unit block mapping BLK_MAP_COL represents which process column of the process grid P_GRID is assigned with the block column of the matrix T_MATRIX to be factorized. That is, a j-th element of the column unit block mapping BLK_MAP_COL stores a process column to which a j-th block column is assigned.

In the example of FIG. 6, a fourth value (that is, BLK_MAP_COL[3]) of the column unit block mapping BLK_MAP_COL is 2, which means that fourth block column B03, B13, B23, B33, B43, B53 of the matrix T_MATRIX to be factorized are mapped to the third process column (P02, P12) of the process grid P_GRID.

The matrix block mapping BLK_MAP provides mapping information between the matrix T_MATRIX to be factorized and the process grid P_GRID by the combination of the row unit block mapping BLK_MAP_ROW and the column unit block mapping BLK_MAP_COL.

The processor 110 assigns the matrix block (i,j) of the matrix T_MATRIX to be factorized to a process derived from the combination of an element i of the row unit block mapping BLK_MAP_ROW and an element j of the column unit block mapping BLK_MAP_COL. For example, the matrix block T_MATRIX[i][j] of the matrix T_MATRIX to be factorized is mapped to a process indicated by P_GRID[BLK_MAP_ROW[i]][BLK_MAP_COL [j]] of the process grid P_GRID.

In the example of FIG. 6, it is understood that the matrix blocks B01, B05, B21, B25, B31, B35, B41, B45 are mapped to the process P01.

FIG. 7 is a detailed flowchart of a matrix block mapping optimization process according to an exemplary embodiment.

FIG. 7 illustrates the matrix block mapping optimizing step S2 in more detail with reference to FIG. 4. The matrix block mapping optimizing step S1 may include a step S21 of generating a second matrix block mapping from the matrix block mapping BLK_MAP and a step S22 of selecting an optimal matrix block mapping among the matrix block mapping BLK_MAP and the second matrix block mapping based on the expected LU factorization computational performance of the matrix T_MATRIX to be factorized.

In step S21, the processor 110 generates the second matrix block mapping from the matrix block mapping BLK_MAP. In step S21, the processor 110 generates a second matrix block mapping by executing at least one of row swap and column swap in the matrix block mapping BLK_MAP at least once.

To this end, the step S21 includes at least one of a step of swapping, by the processor 110, a block column mapping assigned to different process columns in the column unit block mapping BLK_MAP_COL of the matrix block mapping BLK_MAP and a step of swapping, by the processor 110, a row unit block mapping BLK_MAP_ROW assigned to different process rows in the row unit block mapping BLK_MAP_ROW of the matrix block mapping BLK_MAP.

In step S21, the processor 110 may swap (first swap) a block column mapping assigned to different process columns in the column unit block mapping BLK_MAP_COL of the matrix block mapping BLK_MAP. Here, the processor 110 selects block column mappings assigned to different process columns as a swapping target.

For example, the processor 110 may randomly select and swap two block column mappings from the column unit block mapping BLK_MAP_COL. For example, the processor 110 may select and swap one block column mapping from each of a highest process and a lowest process according to a size of a total matrix block assigned to the process in the column unit block mapping BLK_MAP_COL, and select the block column mapping to be swapped in various methods without being limited thereto.

Similarly, in step S21, the processor 110 may swap (second swap) a block row mapping assigned to different process rows in the row unit block mapping BLK_MAP_ROW of the matrix block mapping BLK_MAP. Here, the processor 110 selects block row mappings assigned to different process rows as a swapping target.

For example, the processor 110 may randomly select and swap two block rows mappings from the row unit block mapping BLK_MAP_ROW. For example, the processor 110 may select and swap one block row mapping from each of a highest process and a lowest process according to a size of a total matrix block assigned to the process in the row unit block mapping BLK_MAP_ROW, and select the block row mapping to be swapped in various methods without being limited thereto.

In the step S21, the processor 110 may execute one of the first swap and the second swap. In the step S21, the processor 110 may execute both the first swap and the second swap. In the step S21, the processor 110 may execute the swap multiple times. For example, the processor 110 may execute m1+m2 times in total by combining ml times of the first swap and m2 times of the second swap. Here, m1 and m2 are 0 or natural numbers.

In the step S22, the processor 110 selects an optimal matrix block mapping from the matrix block mapping BLK_MAP and the second matrix block mapping based on the expected LU factorization computational performance of the matrix T_MATRIX to be factorized.

In the step S22, the processor 110 predicts a performance of the parallel LU factorization program with the performance, the execution parameter, and the matrix block mapping BLK_MAP generated in the step S1 as inputs and generates an optimized matrix block mapping based on the result.

The step S22 includes a step of determining, by the processor 110, the expected LU factorization performance of the matrix T_MATRIX to be factorized by each matrix block mapping based on a computation performance of each process of the process grid P_GRID, a communication performance of each process, and the number of block rows assigned to each process row of the process grid P_GRID and the number of block columns assigned to each process column according to each matrix block mapping.

Here, the expected LU factorization performance refers to an expected execution time when the matrix T_MATRIX to be factorized is distributed to each process of the process grid P_GRID according to the given matrix block mapping to execute the parallel LU factorization.

In the step S22, the processor 110 determines an expected LU factorization performance of the matrix T_MATRIX to be factorized by the given matrix block mapping by the following process.

When the step-wise execution time of the LU factorization described above with reference to FIGS. 2A to 2G can be calculated, a full execution time T of the parallel LU factorization algorithm may be predicted. The full execution time T is a sum of execution times of individual iterations.

$$T = {\sum }_{t} {T}^{t} \qquad [ Equation 1 ]$$

If execution times of the steps in a t-th iteration are T_{FACT}^{t}, T_{BCAST}^{t}, T_{SWAP}^{t}, T_{UPDATE}^{t}, the execution time of the t-th iteration is approximated as follows.

T^{t}=max(T_{FACT}^{t}+T_{BCAST}^{t}, T_{SWAP}^{t}, T_{UPDATE}^{t}) [Equation 2]

When the execution time of each step is calculated, the full execution time T may be predicted.

(1) If information about a panel corresponding to a t-th iteration belongs to a j-th process column, the execution time of the FACT step may be predicted as follows.

$${T}_{FACT}^{t} = {max}_{i} ( {n}_{b} ( {α}_{j} + \frac{2 {n}_{b} + 4}{{β}_{j}} ) {log}_{2} P + \frac{( m {p}_{( l )}^{t} - \frac{{n}_{b}}{3} ) \times {n}_{b}^{2}}{{P}_{( i , j )}} ) \qquad [ Equation 3 ]$$

Here, fFACT is a coefficient obtained from the experiment and measurement, mp₍ₜ₎^{t} is the number of rows of the matrix of the process row i in the t-th iteration, and P_{(i,j)} is a computation performance of the process (i,j). P_{(i,j)} may use a predetermined ratio of a theoretical value or a measurement value. αⱼ and βⱼ are numerical values representing a communication performance of the process column j. αⱼ denotes a communication latency and βⱼ denotes a communication bandwidth. αⱼ and βⱼ may use a predetermined ratio of a theoretical value or a measurement value. n_{b} refers to a row size (or a column size) of the matrix block.

(2) An execution time of the BCAST step in the t-th iteration is expressed by the following Equation.

$${T}_{BCAST}^{t} = {max}_{i} ( {α}_{i} + \frac{m {p}_{( l )}^{t} + {n}_{b} + {n}_{b}^{2} + {n}_{b} + 1}{{B}_{t}} ) \qquad [ Equation 4 ]$$

Similarly to the above description, mp₍ₜ₎^{t} is the number of rows of the matrix of the process row i in the t-th iteration and Bᵢ is a broadcast performance of the process row i. Bᵢ may use a predetermined ratio of a theoretical value or a measurement value. n_{b} refers to a row size (or a column size) of the matrix block.

(3) An execution time of the SWAP step in the t-th iteration is expressed by the following Equation 5.

$${T}_{SWAP}^{t} = {max}_{j} ( ( {log}_{z} P + P - 1 ) {α}_{j} + {f}_{SWAP} \times \frac{{nq}_{( j )}^{t} \times {n}_{b}}{{β}_{j}} ) \qquad [ Equation 5 ]$$

Here, f_{SWAP} is a coefficient obtained from the experiment and measurement, nq₍ⱼ₎^{t} is the number of columns of the matrix of the process column j in the t-th iteration, and αⱼ and βⱼ are numerical values representing a communication performance of the process column j. αⱼ denotes a communication latency and βⱼ denotes a communication bandwidth. αⱼ and βⱼ may use a predetermined ratio of a theoretical value or a measurement value. n_{b} refers to a row size (or a column size) of the matrix block.

(4) An execution time of the UPDATE step in the t-th iteration is expressed as follows.

$${T}_{UPDATE}^{t} = {max}_{i , j} ( \frac{2 \times m {p}_{( i )}^{t} \times {nq}_{( j )}^{t} \times {n}_{b} + {nq}_{( j )}^{t} \times {n}_{b}^{2}}{{P}_{( i , j )}} ) \qquad [ Equation 6 ]$$

Similarly to the above description, mp₍ₜ₎^{t} is the number of rows of the matrix of the process row i in the t-th iteration, nq₍ⱼ₎^{t} is the number of columns of the matrix of the process column j in the t-th iteration, and P_{(i,j)} is a computation performance of the process (i,j). P_{(i,j)} may use a predetermined ratio of a theoretical value or a measurement value. n_{b} refers to a row size (or a column size) of the matrix block.

Equations 2 to 6 reflect different computation performances and communication performances to every process to consider that the computation performance varies for every process in the heterogeneous computing environment (for example, P_{(i,j)} represents a computation performance of the process (i,j)).

In Equations 2 to 6, each process has a matrix having a different size according to the performance of each process so that the sizes mp and nq of the matrix allocated to each process reflect it (for example, mp₍ₜ₎^{t}, nq₍ⱼ₎^{t}).

In the meantime, in a circumstance in which a time required for each step is different for every process, the parallel LU factorization algorithm is performed with reference to a process which requires the longest time, so that a maximum value max is taken during the process of calculating a required time for each step.

Additionally, the step S2 may further include a step S23 of setting, by the processor 110, the optimal matrix block mapping selected in step S22 as matrix block mapping BLK_MAP to repeat the step S21 of generating the second matrix block and the step S22 of selecting the optimal matrix block mapping a predetermined number of times.

In step S23, the processor resets one of the current matrix block mapping BLK_MAP and a second matrix block mapping selected as an optimal matrix block mapping in the step S22, as a current matrix block mapping to repeat the steps S21 and S22 a predetermined number of times.

In the step S23, the processor 110 regenerates the second matrix block mapping from the reset current matrix block mapping and reselects an optimal matrix block mapping between the reset current matrix block mapping and the regenerated second matrix block mapping.

FIG. 8 is a detailed flowchart of a process grid determining process according to an exemplary embodiment.

The parallel LU factorization providing method according to the exemplary embodiment may further include a step of disposing, by the processor 110, the plurality of processes in the process grid P_GRID. For example, prior to executing the steps Si to S3 with reference to FIG. 4, the processor 110 may dispose the plurality of processes in the process grid P_GRID.

The step of disposing the plurality of processes in the process grid P_GRID may include a step S31 of determining a total number of processes of the process grid P_GRID based on a performance of at least one node 100 which executes the plurality of processes, a step S32 of determining at least one candidate combination of a process row size and a process column size of the process grid P_GRID based on the total number of processes, and a step S33 of determining an optimal process grid for the plurality of processes with respect to each candidate combination.

In the step S31, the processor 110 determines a total number of processes of the process grid P_GRID based on the performance of at least one node 100 which executes the plurality of processes.

In step S31, the processor 110 determines how many processes is generated for every node 100 and adds them to determine a total number of processes. The total number of processes is denoted by NPROC.

For example, for the node 100 equipped with the GPU, as many processes as the number of GPUs of the node 100 are generated, and for the node 100 in which only the CPU is mounted, but the GPU is not mounted, the processes may be generated twice as the number of CPU for the node 100. The above-described method is illustrative and the processor 100 may determine a total number of processes NPROC by various methods according to the performance of the node 100 which configures the cluster.

In the step S31, the processor 110 may set the total number of processes NPROC to be divided by a predetermined unit. Here, the predetermined unit is an even number, for example, may be determined by an even number (for example, 4) which is not larger than the number of nodes. In the meantime, the processor 110 may determine the number obtained by subtracting a remainder obtained by dividing the total number of processes NPROC calculated previously by the predetermined unit as a total number of processes NPROC.

In the step S32, the processor 110 determines at least one candidate combination for a process row size and a process column size of the process grid P_GRID based on the total number of processes determined in the step S31. A shape of the process grid P_GRID is determined according to the candidate combination.

In the step S32, the processor 110 determines candidate values of P and Q which are sizes of the row and the column of the process grid P_GRID to make P×Q=NPROC.

In the step S32, the processor 110 may determine a candidate combination of P and Q which satisfies P×Q=NPROC. For example, NPROC is 48 and the candidate combination (P,Q) may include (4, 12), (6, 8), (8, 6), and (12, 4). In this case, when one of the P and Q is determined, the other one may be automatically determined.

Here, P or Q becomes smaller than the predetermined unit (for example 4) described above in the step S31, the P or Q may be excluded from the candidate combination.

In the step S33, the processor 110 determines an optimal process grid for a plurality of processes for each candidate combination of at least one candidate combination determined in the step S32.

In the step S33, the processor 110 may determine a position of each process in the process grid P_GRID.

The processor 110 may determine an optimal process grid by grouping the processes having similar capabilities in the same row and column of the process grid P_GRID as much as possible.

For example, the processor 110 may determine the performance of the process based on the computation performance, the communication performance, and the memory performance of the process, align the processes according to the determined performance, and dispose the processes in the process grid P_GRID in every row or every column in a descending order or an ascending order of a computing power of the processor, for each candidate combination of the row size P and the column size Q of the process grid P_GRID.

For example, the processor 110 groups the plurality of processes according to the performance and the processes in the same group may be disposed in the process grid P_GRID to be located in an adjacent row or an adjacent column. The processor 110 may preferentially dispose a group having a high performance.

For example, the processor 110 groups the processes in an execution node unit and the processes to be executed in the same node may be disposed in the process grid P_GRID to be located in an adjacent row or an adjacent column. In this case, the processor 110 may preferentially dispose the nodes having a higher performance or a larger number of processes in the process grid P_GRID.

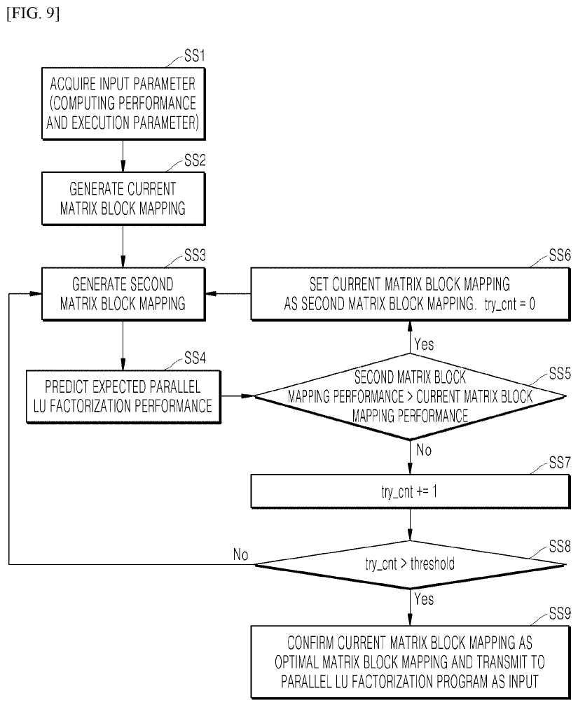

FIG. 9 is a flowchart fully illustrating a parallel LU factorization providing process according to an exemplary embodiment.

In a step SS1, the processor 110 acquires an input parameter. The input parameter includes the performance and the execution parameter described above with reference to FIG. 4.

In step SS2, the processor 110 generates current matrix block mapping. The step SS2 corresponds to the step S1 referring to FIG. 4.

The steps SS3 to SS9 correspond to the step S2 referring to FIG. 4.

In the step S33, the processor 110 randomly assigns one row or column to another row or column in the current matrix block mapping generated in the step SS2 to generate second matrix block mapping. The step SS3 corresponds to the step S21 referring to FIG. 7.

In the step SS4, the processor 110 predicts the expected parallel LU factorization performance by the current matrix block mapping and the second matrix block mapping.

In the step SS5, the processor 110 compares the expected performance of the current matrix block mapping and the expected performance of the second matrix block mapping. For example, the expected performance includes a predicted execution time.

As a comparison result of the step SS5, if the expected performance of the second matrix block mapping is better than the expected performance of the current matrix block mapping (for example, an expected execution time of the second matrix block mapping is shorter), the processor 110 sets the second matrix block mapping as current matrix block mapping in step SS6 to reset a trial count try_cnt to 0.

As a comparison result of the step SS5, if the expected performance of the current matrix block mapping is better than the expected performance of the second matrix block mapping (for example, an expected execution time of the current matrix block mapping is shorter), the processor 110 increments the trial count try_cnt by one in step SS7.

In step SS8, the processor 110 identifies whether the iteration count try_cnt reaches a predetermined threshold. If the iteration count try_cnt is equal to or smaller than the predetermined threshold in the step SS8, the sequence goes to the step SS3. If the iteration count try_cnt is larger than the predetermined threshold in the step SS8, the sequence goes to the step SS9 to confirm the current matrix block mapping as the optimal matrix block mapping and provide the optimal matrix block mapping to the parallel LU factorization.

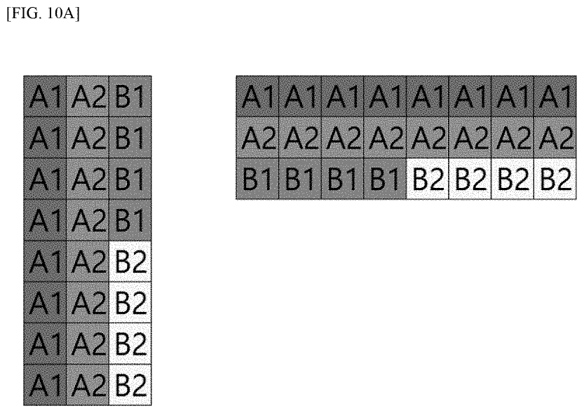

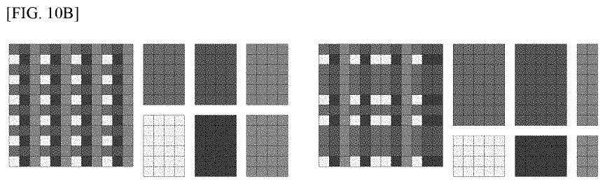

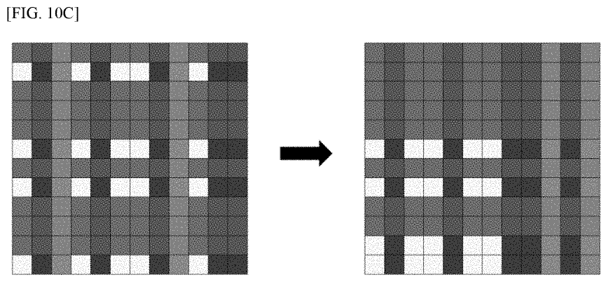

FIGS. 10A to 10C are views for exemplarily explaining a parallel LU factorization providing process according to an exemplary embodiment.

FIG. 10A illustrates an exemplary process grid generation result.

For example, it is assumed that there are two A type nodes equipped with eight A100 GPUs and two B type nodes equipped with four V100 GPUs. In each A type node, eight processes are generated and in each B type nodes, four processes are generated. Accordingly, a total of 24 processes are generated.

There are six candidate combinations of 4×6, 8×3, 12×2, 6×4, 3×8, 2×12 for the rows P and the columns Q of the process grid P_GRID. Among them, when 8×3 and 3×8 are taken as an example, the processes may be disposed as illustrated in FIG. 10A.

FIG. 10B illustrates an exemplary matrix block generation result.

According to the parallel LU factorization providing method according to the exemplary embodiment, the blocks in the same column in the matrix T_MATRIX to be factorized are distributed to the processes belonging to the same process column in the two-dimensional process grid P_GRID and the blocks in the same row in the matrix T_MATRIX to be factorized are distributed to the processes belonging to the same process row in the two-dimensional process grid P_GRID.

When the matrix distribution condition proposed by the present disclosure is used, not only a block-cyclic method, but also other various methods are also possible.

According to the matrix distribution method according to the exemplary embodiment, not only the matrix distribution by the block-cyclic distribution, but also matrix distribution by other various methods is also possible. The matrix distribution method according to the exemplary embodiment provides matrix distribution in which both the row distribution and the column distribution are free, and the performance of the parallel LU factorization algorithm may be improved in the heterogeneous computing environment by the matrix distribution in which the row distribution and the column distribution are free.

For example, when six processes are disposed by 2×3, and in the left mapping, the performance including the computation performance and the memory capacity of all the processes is the same, a matrix block generating result by the parallel LU factorization providing method according to the exemplary embodiment is shown. This is the same result as the distribution by the block-cyclic distribution.

In the right mapping, the performances of the processes are different and an example of generating the matrix block mapping when the computing performances and the memory capacities of a third process column and a second process row are relatively low is shown.

In a sixth block column in the entire matrix, it is understood that the corresponding block column is distributed to the first process column instead of being distributed to the third process column as an order. The same situation occurred in the fourth row in the entire matrix.

FIG. 10B illustrates an exemplary matrix block mapping optimization result.

According to the matrix distribution according to the exemplary embodiment, various matrix distributions are possible even with the same performance and parallel LU factorization algorithm execution parameter, which is distinguished from the block-cyclic distribution in which the matrix distribution is uniquely determined by the same parameter.

Further, the matrix distribution according to the exemplary embodiment provides optimal matrix distribution in which the algorithm efficiently runs with the given performance and parallel LU factorization algorithm execution parameter.

FIG. 10C illustrates an optimal result found for the mapping generated in FIG. 10B.

It is confirmed that the matrix blocks distributed to the third process row and the second process column are concentrated toward the back. As a result, even though the block mapping is changed, a total amount of the matrix blocks distributed for every process is maintained the same.

According to an exemplary embodiment, a matrix distribution method having a degree of freedom of distribution for both a process row and a process column is provided. Further, the parallel LU factorization providing algorithm according to the exemplary embodiment considers a performance of a memory which is available for each process as well as the performance, that is, the computation performance and the communication performance. Specifically, according to the exemplary embodiment, the optimal matrix distribution may be selected by collectively considering the computation performance, the communication performance, and the memory performance of the process.

Hereinafter, a parallel LU factorization providing method according to an additional exemplary embodiment and a node for executing the method will be described.

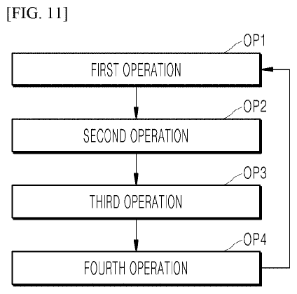

FIG. 11 illustrates a parallel LU factorization providing process according to another exemplary embodiment.

Referring to FIG. 3, the node 100 includes at least one processor 110 and a memory 120 which stores at least one instruction executable by at least one processor 110 and is configured, when the at least one instruction is executed by the processor 110, to cause the processor 110 to perform a first operation OP1 of generating a plurality of candidate matrix block mappings representing mapping information to distribute a plurality of matrix blocks corresponding to at least a part of the matrix T_MATRIX to be factorized to a plurality of processes which executes the LU factorization, a second operation OP2 of predicting an expected LU factorization performance of the matrix T_MATRIX to be factorized based on at least one candidate matrix block mapping which satisfies a predetermined memory limit condition, among the plurality of candidate matrix block mappings, and a third operation OP3 of determining an optimal candidate matrix block mapping for a plurality of matrix blocks among at least one candidate matrix block mapping which satisfies the memory limit condition, based on the predicted expected LU factorization performance.

Here, each matrix block may correspond to submatrix obtained by dividing the matrix T_MATRIX to be factorized into block rows and block columns having a predetermined size. For example, the plurality of matrix blocks may correspond to an arbitrary block row or block column of the matrix T_MATRIX to be factorized.

Here, the memory limit condition is a parameter associated with a memory performance of the process and for example, refers to a condition that does not exceed an available memory capacity of the process and includes a condition associated with the memory performance (for example, a maximum capacity, an available amount, an access time, and a latency time) of each process without being limited thereto.

The plurality of processes is disposed in a predetermined process row and process column on the process grid P_GRID. The mapping information of the first operation OP1 includes process row information and process column information (for example, information indicating that the matrix block block1 is distributed to a process disposed in a r-th process row and a c-th process column of the process grid) for each matrix block of the plurality of matrix blocks.

At least one instruction stored in the memory 120 may be configured, when the instruction is executed by the processor 110, to cause the processor 110 to fix one of a row direction and a column direction in a round-robin manner to execute the first operation OP1.

At least one instruction stored in the memory 120 may be configured, when the instruction is executed by the processor 110, to cause the processor 110 to select a last block row or a last block column of the matrix to be factorized which has not been assigned, as a plurality of matrix blocks along a remaining direction of the row direction and the column direction to execute the first operation OP1.

In the meantime, the plurality of processes is disposed in a predetermined process row and a process column on the process grid P_GRID and at least one instruction stored in the memory 120 may be configured, when the instruction is executed by the processor 110, to cause the processor 110 to generate a plurality of candidate matrix block mappings by assigning the plurality of matrix blocks to each process row or each process column along the remaining direction of the row direction and the column direction to execute the first operation OP1.

At least one instruction stored in the memory 120 may be configured, when the instruction is executed by the processor 110, to cause the processor 110 to predict an expected LU factorization performance using a performance prediction model based on the computation performance, the memory performance, and the communication performance of the plurality of processes to execute the second operation OP2.

Hereinafter, a performance prediction model according to an additional exemplary embodiment will be described.

A full execution time of the LU factorization may be represented by a sum of the execution time of each iteration. Further, the execution time of each iteration may be determined by a maximum value of an execution of the FACT-BCAST step, an execution time of the SWAP step, and an execution time of the UPDATE step. This is because the FACT-BCAST step, the SWAP step, and the UPDATE step overlap to be simultaneously executed. Therefore, the following equation may be obtained.

$$T = {\sum }_{0 \leq i < n} {T}^{i} = {\sum }_{0 \leq i < n} max ( {T}_{FACT}^{i} + {T}_{BCAST}^{i} , {T}_{SWAP}^{i} , {T}_{UPDATE}^{i} ) \qquad [ Equation 7 ]$$

Here, n=[(N+1)/n_{b}] indicates a total iteration count to complete the LU factorization. Each iteration is denoted by i. t is used as a reference character denoting an execution time in the following equations. The process row is denoted by p and the process column is denoted by q. Total numbers of the process columns and rows are denoted by P and Q.

Further, qᵢ denotes the number of a process column having a panel of an i-th iteration. Accordingly, the numbers of rows and columns of the submatrix of the process (p,q) may be denoted by mpⁱₚ and npⁱ_{q}.

Now, an equation for calculating the execution time of each step FACT, BCAST, SWAP, UPDATE will be described.

Equation 8 is an equation for calculating an execution time of the FACT step. According to the above-described notation, T_{FACT,p,q}_{^{t}}ⁱ indicates a FACT step execution time of a p-th process of P processes (0, qⁱ), (1, qⁱ), . . . , (P−1, qⁱ) which perform the FACT.

$${T}_{FACT}^{t} = {max}_{0 \leq p < P} {T}_{FACT , , {q}^{i}}^{i} = {max}_{0 \leq p < P} ( 2 {t}_{PCIe , p , {q}^{t}}^{i} + {t}_{Camm , p , {q}^{t}}^{i} + {t}_{BLAS , p , {q}^{i}}^{i} ) \qquad [ Equation 8 ]$$

T_{FACT,p,q}_{^{t}}^{t} is factorized into three terms t_{PCI,p,q}_{^{t}}ⁱ, t_{Comm,p,q}_{^{t}}ⁱ and t_{BLAS,p,q}_{^{t}}^{t}.

If the matrix is stored in the CPU, t_{PCI,p,q}_{^{t}}ⁱ the is simply 0 and if the matrix is stored in an accelerator such as a GPU, it is a time taken to transmit the data to the CPU. The data is transmitted to the CPU to process the task and then stored in the accelerator again so that 2 is multiplied. A total amount of data is 16 mpⁱₚn_{b} bites.

t_{Comm,p,q}_{^{t}}ⁱ indicates a communication time of the FACT step. It means a time taken to transmit and receive 16n_{b}+32 bite data between processes which participate in the FACT n_{b} times in total.

t_{BLAS,p,q}_{^{t}}^{t} is a real number computational time of the FACT step. It is an execution time for many small BLAS operations called in the FACT step.

Equation 9 is an equation for calculating an execution time of the BCAST step.

$${T}_{BCAST}^{i} = {max}_{0 \leq p < P} {T}_{BCAST , p}^{i} = {max}_{0 \leq p < P} {t}_{Broadcast , p}^{i} \qquad [ Equation 9 ]$$

The broadcast communication is independently executed in P process rows, so that a total execution time refers to a broadcast execution time in a row that it takes a longest time. t_{Broascase,p}ⁱ is a time taken to broadcast 8(mpⁱₚn_{b}+n²_{b}+n^{b}+1) bites in the process row p.

Equation 10 is an equation for calculating an execution time of the SWAP step.

$${T}_{SWAP}^{i} = {max}_{0 \leq q < Q} {T}_{SWAP , q}^{i} = {max}_{0 \leq q < Q} ⌊ ( {log}_{2} P + P - 1 ) {α}_{q} + 2 ( {n}_{b} + {nq}_{q}^{i} ) {β}_{q} ⌋ \qquad [ Equation 10 ]$$

For example, f_{SWAP} coefficient may be fixed to 2. β_{q} indicates a reciprocal number of the communication bandwidth.

Equation 11 is an equation for calculating an execution time of the UPDATE step.

$${T}_{UPDATE}^{i} = {max}_{0 \leq p < P , 0 \leq q < Q} {T}_{UPDATE , p , q}^{i} = {max}_{0 \leq p < P , 0 \leq q < Q} ( {t}_{DGEMM , p , q}^{i} + {t}_{Overhead , p , q} ) \qquad [ Equation 11 ]$$

tDEGMM,p,qⁱ is a time taken for the process (p,q) to perform DGEMM operation with a size of mpⁱ_{p×nq}ⁱ_{q}×n_b. t_{Overhead,p,q} is a kernel launch overhead of the process (p,q). This term is necessary because when the DGEMM operation is performed in the accelerator such as a GPU, the overhead is increased.

Terms t_{Comm,p,q}_{^{t}}ⁱ, tDEGMM,p,qⁱ and the like denoted by lower cases in the above Equations use theoretical performance value or a measurement value.

Returning to FIG. 11 again, at least one instruction stored in the memory 120 may be configured to cause the processor 110 to perform a fourth operation of repeating the first operation to third operation on each of the plurality of remaining matrix blocks of the matrix to be factorized until all the matrix blocks of the matrix T_MATRIX to be factorized are distributed when the instruction is executed by the processor 110.

When at least one instruction stored in the memory 120 is executed by the processor 110, the instruction may be configured to cause the processor 110 to fix the row direction in a round-robin manner, acquire the column-direction optimal candidate matrix block mapping by performing the first to fourth operations (OP1, OP2, OP3, and OP4) along the column direction, fix the column direction in the round-robin manner, acquire the row-direction optimal candidate matrix block mapping by performing the first to fourth operations (OP1, OP2, OP3, and OP4) along the row direction, and determine final matrix block mapping for the matrix T_MATRIX to be factorized based on the expected LU factorization performance of the matrix T_MATRIX to be factorized by the column-direction optimal candidate matrix block mapping and the row-direction optimal candidate matrix block mapping.

The processor 110 may distribute the matrix blocks of the matrix T_MATRIX to be factorized to the plurality of processes based on the determined final matrix block mapping.

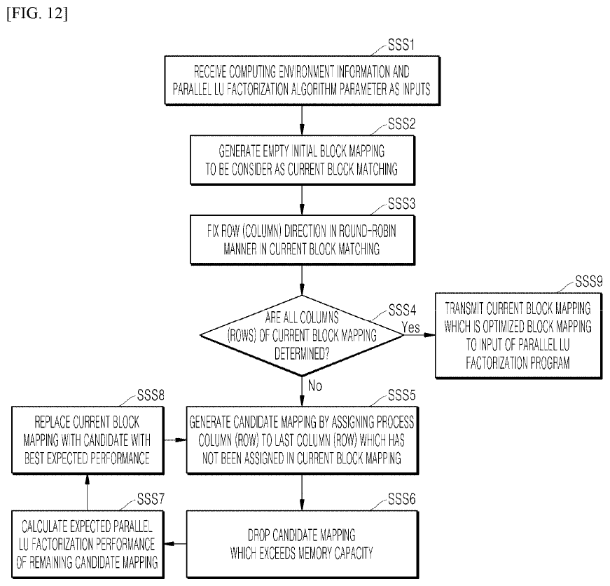

In an example, the first operation OP1 corresponds to steps SSS3, SSS4, and SSS5 referring to FIG. 12. The second operation corresponds to steps SSS6 and SSS7 referring to FIG. 12. The third operation corresponds to the step SSS8 referring to FIG. 12.

The parallel LU factorization providing method according to the exemplary embodiment includes a step of performing a first operation OP1 of generating a plurality of candidate matrix block mappings representing mapping information to distribute a plurality of matrix blocks corresponding to at least a part of the matrix T_MATRIX to be factorized to a plurality of processes which executes the LU factorization, a step of performing a second operation OP2 of predicting an expected LU factorization performance of the matrix T_MATRIX to be factorized based on at least one candidate matrix block mapping which satisfies a predetermined memory limit condition, among the plurality of candidate matrix block mappings, and a step of performing a third operation OP3 which determines an optimal candidate matrix block mapping for a plurality of matrix blocks among at least one candidate matrix block mapping which satisfies the memory limit condition, based on the expected LU factorization performance, by the processor 110.

Here, the plurality of matrix blocks may correspond to one block column or one block row of the matrix T_MATRIX to be factorized.

The step of performing the first operation OP1 may include a step of fixing, by the processor 110, one of the row direction and the column direction in a round-robin manner and a step of selecting a last block row or last block column of the matrix T_MATRIX to be factorized which has not been assigned, as a plurality of matrix blocks along a remaining direction of the row direction and the column direction.

Here, the plurality of processes is disposed in a predetermined process row and process column on the process grid P_GRID and the step of performing the first operation OP1 may further include a step of generating a plurality of candidate matrix block mappings by assigning the plurality of matrix blocks to each process row or each process column along the remaining direction of the row direction and the column direction.

The step of performing the second operation OP2 includes a step of predicting the expected LU factorization performance using a performance prediction model based on a computation performance, a memory performance, and a communication performance of a plurality of processes, by the processor 110.

The parallel LU factorization method according to the exemplary embodiment may further include a step of performing the fourth operation OP4 of repeating the step of performing the first operation OP1 to the step of performing the third operation OP3 on each of the plurality of remaining matrix blocks of the matrix T_MATRIX to be factorized until all the matrix blocks of the matrix T_MATRIX to be factorized are distributed, by the processor 110.

For example, the step of performing the fourth operation OP4 may repeat the step of performing the first operation OP1, the step of performing the second operation OP2, and the step of performing the third operation OP3 on each of the plurality of remaining matrix blocks of the matrix T_MATRIX to be factorized until all the matrix blocks of the matrix T_MATRIX to be factorized are distributed.

In the meantime, the parallel LU factorization providing method according to the exemplary embodiment may include a step of fixing the row direction in a round-robin manner and acquiring the column-direction optimal candidate matrix block mapping by performing the steps of performing the first to fourth operations (OP1, OP2, OP3, and OP4) along the column direction, a step of fixing the column direction in the round-robin manner, acquiring the row-direction optimal candidate matrix block mapping by performing the steps of performing the first to fourth operations (OP1, OP2, OP3, and OP4) along the row direction, and a step of determining final matrix block mapping for the matrix T_MATRIX to be factorized based on the expected LU factorization performance of the matrix T_MATRIX to be factorized by the column-direction optimal candidate matrix block mapping and the row-direction optimal candidate matrix block mapping, by the processor 110.

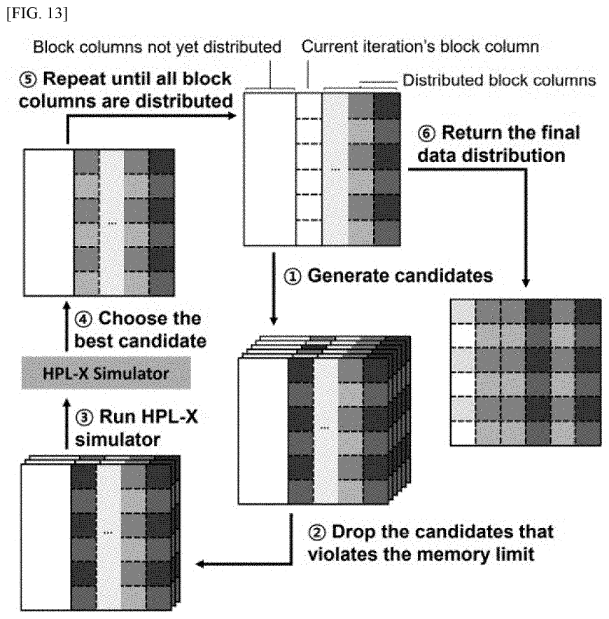

Hereinafter, an exemplary flow of the parallel LU factorization providing method will be described in more detail with reference to FIGS. 12 and 13.

FIG. 12 is a detailed flowchart of a method for providing parallel LU factorization according to another exemplary embodiment.

In a step SSS1, the node 100 receives computing environment information and a parallel LU factorization algorithm parameter.

In the step SSS2, the sequence starts from an empty matrix block mapping, and then in the following steps, the processor 110 assigns each block row/column to the process row/column and when each block row/column is assigned to the process row/column, the block low/column is assigned to a process row/column which is expected to show the highest performance according to the above-described LU factorization performance prediction model.

In an example, the parallel LU factorization providing method according to still another exemplary embodiment may repeat the following processes in the row and column direction two times in total.

In a step SSS3, the processor 110 fixes one of the row direction and the column direction in the round-robin manner to remove the degree of freedom.

In a step SSS4, the processor 110 determines whether all the columns (or rows) of the current block mapping are determined.

When all the columns (or rows) are determined, the current block mapping is determined as a final matrix block mapping and the determination is transmitted to an input of the parallel LU factorization program. If there is a column (or row) which is not determined, the following is performed.

Mapping for a process column (or a process row) to which each block column (or block row) is assigned is determined while performing the following steps from the last block column (or last block row) to the first block column (or the first block row).

In a step SSS5, the processor 110 generates candidate matrix mapping blocks assumed to be assigned to each process column (or process row) for a block column (or block row) to be currently assigned. Here, the block column (or block row) to be currently assigned refers to a final block column (or a block row) which has not been assigned.

In a step SSS5, the processor 110 generates candidate matrix mapping blocks (or candidate matrix mapping blocks as many as the number P of entire process rows) as many as the number Q of entire process columns.

In a step SSS6, among the plurality of candidate matrix mapping blocks generated in the step SSS5, any one of plurality of processes of the process grid P_GRID which exceeds an available memory limit s removed from the candidate.

In a step SSS7, the processor 110 performs the LU factorization performance prediction of the remaining candidates in the step SSS6. To this end, the above-described performance prediction model is executed.

In a step SSS5, the processor 110 selects a candidate matrix block mapping having the best performance predicted in the step SSS7. By doing this, the assignment of one block column (or the block row) is completed.

The above-described processes are repeated until all the block columns (or block rows) are assigned to the process column (or the process row) in step SSS4 and when the process is completed, the matrix block mapping in which all the block columns (or block rows) are completely assigned is returned in step SSS5.

Between the column-direction optimal matrix block mapping (generated by fixing the row direction) and the row-direction optimal matrix block mapping (generated by fixing the column direction) obtained as a result of performing the above-described steps by fixing the row direction and fixing the column direction, one having a better expected LU factorization performance is selected as final block mapping.

FIG. 13 is a view for exemplarily explaining a parallel LU factorization providing process according to another exemplary embodiment.

An LU factorization providing algorithm according to the exemplary embodiment repeats the following processes on the row and column directions two times in a total. First, one of the row and column directions is fixed by a round-robin manner to remove the degree of freedom. In the following description, it is assumed that the row direction is fixed.

In order to determine the column direction mapping, mapping to assign to which process column is determined while performing 1) to 6) steps from the last block column to the first block column.

1) Generate mapping candidates assumed to be assigned to each process column with respect to a block column to be currently distributed (=a last block column which has not been assigned). A total of Q candidates is generated (corresponds to OP1 of FIG. 11 and SSS5 of FIG. 12, respectively).

2) Among them, a candidate which exceeds the memory limit is removed from the candidates (corresponds to OP2 of FIG. 11 and SSS6 of FIG. 12).

3) Perform LU factorization performance prediction for the generated candidates. In FIG. 13, HPL-X simulator may predict the LU factorization performance using the above-described LU factorization performance prediction model (corresponds to OP2 of FIG. 11 and SSS7 of FIG. 12).

4) Select a candidate having the best predicted performance. By doing this, one block column assignment is completed (corresponds to OP3 of FIG. 11 and SSS7 of FIG. 12).

5) Repeat this process until all the block columns are assigned to the process column (see OP4 of FIG. 11 and repeat until SSS4 of FIG. 12 is satisfied).

6) Return mapping in which all block column assignment is completed.

The mapping when the row direction is fixed is completely generated by doing this and the above processes 1) to 6) are repeated one more time by fixing the column direction in a round-robin manner and between two generated matrix block mapping, one having the better expected LU factorization performance is selected as final block mapping.

The technique proposed in the present disclosure is a technique which is immediately utilized in a plurality of high performance computing/supercomputing applications and specifically, may be immediately applied to enhance the performance of the high performance UNPACK (HPL) program. The HPL is utilized as an in-factor standard to measure a performance of the high performance computer/supercomputer system so that it is easy to enter/utilize the established high performance computer/supercomputer market with this technology.

The above-described method according to an exemplary embodiment of the present disclosure may be implemented in a computer program-recorded medium by a computer readable code. That is, the method according to the exemplary embodiment may be provided to a non-transitory computer readable recording medium in which a computer program including at least one instruction configured to execute the method according to the exemplary embodiment by a processor is stored.

The non-transitory computer-readable recording medium includes all types of recording devices in which data readable by a computer system is stored. Examples of the non-transitory computer readable recording medium may include a hard disk drive (HDD), a solid state disk (SSD), a silicon disk drive (SDD), ROM, RAM, CD-ROM, a magnetic tape, a floppy disk, an optical data storage device, and the like.

The description of the exemplary embodiment of the present disclosure described above is illustrative only and it is understood by those skilled in the art that the present invention may be modified to a specific type without changing the technical spirit of an essential feature of the present invention. Thus, it is to be appreciated that embodiments described above are intended to be illustrative in every sense, and not restrictive. For example, a component which is described as a singular form may be embodied to be dispersed or components which are dispersed may be embodied to be a combined form. For example, steps for executing the method may be executed in a different order.

The scope of the present invention is represented by the claims to be described below rather than the detailed description, and it is to be interpreted that the meaning and scope of the claims and all the changes or modified forms derived from the equivalents thereof come within the scope of the present invention.

### STATEMENT REGARDING GOVERNMENT SUPPORT

This invention was supported at least in part by Ministry of Science and ICT of South Korean government for research project, the title of which is “High-Performance Programming Environment and Computing System Development” (Project Number: 1711105288) managed by NRF (National Research Foundation of Korea).

What is claimed is:

1. A node which executes a parallel LU factorization providing method, comprising:
at least one processor; and
a memory which stores at least one instruction executable by the at least one processor,
wherein when the at least one instruction is executed by the processor, the instruction is configured to cause the processor to perform operations comprising:
a first operation of generating a plurality of candidate matrix block mappings representing mapping information to distribute a plurality of matrix blocks corresponding to at least a part of a matrix to be factorized to a plurality of processes which executes the LU factorization;
a second operation of predicting an expected LU factorization performance of the matrix to be factorized based on at least one candidate matrix block mapping which satisfies a predetermined memory limit condition, among the plurality of candidate matrix block mappings, and
a third operation which determines an optimal candidate matrix block mapping for the plurality of matrix blocks among the at least one candidate matrix block mapping which satisfies the memory limit condition, based on the expected LU factorization performance.

2. The node according to claim 1, wherein each matrix block corresponds to a submatrix obtained by dividing the matrix to be factorized into a block row and a block column with a predetermined size.

3. The node according to claim 1, wherein the plurality of processes is disposed in predetermined process row and process column on a process grid and the mapping information includes process row information and process column information of the process grid for each matrix block of the plurality of matrix blocks.

4. The node according to claim 1, wherein the at least one instruction is configured to cause the processor to fix one of a row direction and a column direction in a round-robin manner to execute the first operation when the instruction is executed by the processor.

5. The node according to claim 4, wherein the at least one instruction is configured to cause the processor to select a final block row or a final block column of the matrix to be factorized which has not been assigned, as the plurality of matrix blocks, along a remaining direction of the row direction and the column direction to execute the first operation when the instruction is executed by the processor.

6. The node according to claim 4, wherein the plurality of processes is disposed in predetermined process row and process column on the process grid and the at least one instruction is configured to cause the processor to generate the plurality of candidate matrix block mappings by assigning the plurality of matrix blocks to each process row or each process column along the remaining direction of the row direction and the column direction to execute the first operation when the instruction is executed by the processor.

7. The node according to claim 1, wherein the second operation is configured to predict the expected LU factorization performance using a performance prediction model based on a computation performance, a memory performance, and a communication performance of the plurality of processes.

8. The node according to claim 1, wherein the at least one instruction is configured, when the instruction is executed by the processor, to cause the processor to perform a fourth operation of repeating the first to third operations on the plurality of remaining matrix blocks of the matrix to be factorized until all the matrix blocks of the matrix to be factorized is distributed.

9. The node according to claim 8, wherein the at least one instruction is configured, when the at least one instruction is executed by the processor, to cause the processor to fix a row direction in a round-robin manner and acquire a column-direction optimal candidate matrix block mapping by performing the first to fourth operations along a column direction, to fix the column direction in the round-robin manner and acquire a row-direction optimal candidate matrix block mapping by performing the first to fourth operations along the row direction, and to determine a final matrix block mapping for the matrix to be factorized based on the expected LU factorization performance of the matrix to be factorized by the row-direction optimal candidate matrix block mapping and the column-direction optimal candidate matrix block mapping.

10. The node according to claim 9, wherein the at least one instruction is configured, when the at least one instruction is executed by the processor, to cause the processor to assign the matrix to be factorized to the plurality of processes based on the final matrix block mapping.

11. A parallel LU factorization providing method, comprising:
performing a first operation of generating a plurality of candidate matrix block mappings representing mapping information to distribute a plurality of matrix blocks corresponding to at least a part of a matrix to be factorized to a plurality of processes which executes the LU factorization;
performing a second operation of predicting an expected LU factorization performance of the matrix to be factorized based on at least one candidate matrix block mapping which satisfies a predetermined memory limit condition, among the plurality of candidate matrix block mappings, and
performing a third operation which determines an optimal candidate matrix block mapping for the plurality of matrix blocks among the at least one candidate matrix block mapping which satisfies the memory limit condition, based on the expected LU factorization performance.

12. The parallel LU factorization providing method according to claim 11, wherein the performing of a first operation comprises:
fixing any one of a row direction and a column direction in a round-robin manner; and
selecting a last block row or last block column of the matrix to be factorized which has not been assigned, as the plurality of matrix blocks along a remaining direction of the row direction and the column direction.

13. The parallel LU factorization providing method according to claim 12, wherein the plurality of processes is disposed in a predetermined process row and process column on a process grid and
the performing of a first operation further comprises:
generating the plurality of candidate matrix block mapping by assigning the plurality of matrix blocks to each process row or each process column along the remaining direction of the row direction and the column direction.

14. The parallel LU factorization providing method according to claim 11, wherein the performing of a second operation comprises:
predicting the expected LU factorization performance using a performance prediction model based on a computation performance, a memory performance, and a communication performance of the plurality of processes.

15. The parallel LU factorization providing method according to claim 11, further comprising:
performing a fourth operation of repeating the performing of the first operation to the performing of the third operation on the plurality of remaining matrix blocks of the matrix to be factorized until all the matrix blocks of the matrix to be factorized are distributed.

16. The parallel LU factorization providing method according to claim 15, further comprising:
fixing a row direction in a round-robin manner and acquiring a column-direction optimal candidate matrix block mapping by performing the performing of the first to fourth operations along a column direction;
fixing the column direction in the round-robin manner and acquiring a row-direction optimal candidate matrix block mapping by performing the performing of the first to fourth operations along the row direction; and
determining a final matrix block mapping for the matrix to be factorized based on the expected LU factorization performance by the row-direction optimal candidate matrix block mapping and the column-direction optimal candidate matrix block mapping.

17. A computer readable non-transitory recording medium stored with computer program instructions executed by at least one processor configured to cause the at least one processor to perform the parallel LU factorization providing method according to claim 11.
